(19) United States
(12) Patent Application Publication
(10) Pub. No.: US 2009/0106648 A1
(43) Pub. Date: Apr. 23, 2009

(54) POSITIONING CONTENT USING A GRID

(75) Inventors: Alex Mogilevsky, Bellevue, WA (US); Markus Mielke, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/874,938

(22) Filed: Oct. 19, 2007

(51) Int. Cl. G06F 3/048

(52) U.S. Cl. 715/243

(57) ABSTRACT

Various embodiments provide a grid positioning system which allows grid lines to be established based upon either an implicit grid or an explicit grid. Further, at least some embodiments provide a grid positioning system which allows a repeating mechanism to be employed which is ideally suited to adapt to different screen or display resolutions. Further, various embodiments provide a language which defines a grid unit that can be utilized to allow positioning in relation to grid lines.

### BACKGROUND

A grid is a structure made up of intersecting axes that are used to structure content. For example, a grid can comprise a series of intersecting vertical and horizontal axes that are used to structure content on a page. The grid essentially serves as a mechanism by which a designer can organize text and images in a coherent way.

FIG. 1 shows an example page generally at 100 that includes a grid superimposed over the page. In this example, the grid includes a number of horizontal lines 102 and vertical lines 104 which collectively define the grid. In this example, the grid has been used to organize text which appears on the page. Specifically, here the text “Welcome”, “Agenda Items”, “Item 1”, “Item 2”, and “Item 3” have been organized on the page using the illustrated grid.

Various grid systems have provided great value to print designers for organizing printed content for many years. Yet, grid systems have lagged in the electronic age. Specifically, challenges posed by electronic devices, such as various computing devices, have made grid utilization somewhat inflexible. For example, electronic devices come in many shapes and sizes and vary broadly across wide scenarios. While a single, fixed-sized grid may work well for a subset of these devices, fixed-sized grid systems fail to provide a flexible solution across a wide variety of devices. Such is especially the case in various web scenarios where web content can be consumed on a variety of different devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a grid positioning system which allows grid lines to be established based upon either an implicit grid or an explicit grid. Further, at least some embodiments provide a grid positioning system which allows a repeating mechanism to be employed which is ideally suited to adapt to different screen or display resolutions. Further, various embodiments provide a language which defines a grid unit that can be utilized to allow positioning in relation to grid lines.

### BRIEF DESCRIPTION OF THE DRAWINGS

The same numbers are used throughout the drawings to reference like features.

FIG. 1 shows an example page that includes a grid superimposed over the page.

FIG. 2 illustrates an example operating environment in which the inventive embodiments can be employed.

FIG. 3 illustrates an example layout in accordance with one or more embodiments.

FIG. 4 illustrates a flow diagram that describes steps in a method in accordance with one or more embodiments.

FIG. 5 illustrates a flow diagram that describes steps in a method in accordance with one or more embodiments.

FIG. 6 illustrates an example system that can be used to implement one or more embodiments.

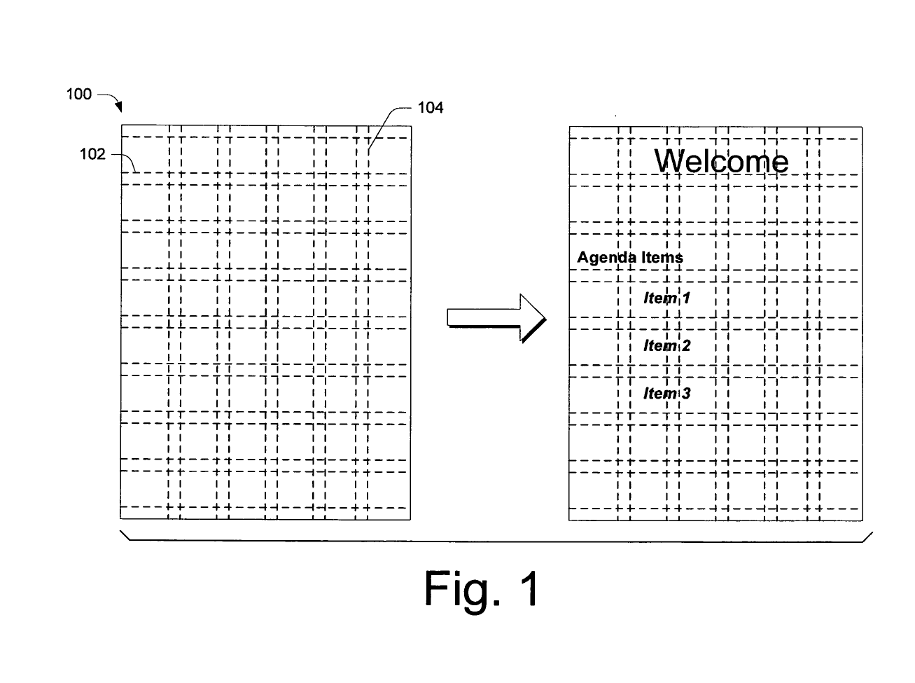

### DETAILED DESCRIPTION

Overview

Various embodiments provide a grid positioning system which allows grid lines to be established based upon either an implicit grid or an explicit grid. Further, at least some embodiments provide a grid positioning system which allows a repeating mechanism to be employed which is ideally suited to adapt to different screen or display resolutions. Further, various embodiments provide a language which defines a grid unit that can be utilized to allow positioning in relation to grid lines.

In at least some embodiments, the grid positioning system provides capabilities for sizing and positioning content in terms of a scalable grid. The grid can be specified directly by an author—termed an explicit grid—, or can be implied from existing two-dimensional structures such as tables or multi-column elements-termed an implied or implicit grid.

These grids serve as anchoring points, in a sense, to allow content to be positioned relative to the grids. Since the grids can be flexibly defined, content can now be easily positioned in ways that were not possible before, or were at least very difficult to achieve. Hence, the inventive techniques represent a departure from past positioning techniques that position content based only on pixel position, percentage of page size, multiples of font size or multiples of some other complicated structure. The inventive techniques are particularly useful in the context of web documents which can be rendered on various types of devices having different form factors.

In the discussion that follows, a section entitled “Operating Environment” is provided and describes one example of an operating environment that can be utilized in accordance with one or more embodiments. Following this, a section entitled “Example Grid Unit” is provided and describes the notion of a grid unit and how grid units can be used as part of an expression that enables content to be flexibly positioned relative to a grid-whether an explicit grid, an implied grid, or an implied grid with explicit declarations. Following this, a section entitled “Example Methods” is provided and describes example methods in accordance with one or more embodiments. Lastly, a section entitled “Example System” is provided and describes an example system that can be used to implement one or more embodiments.

Operating Environment

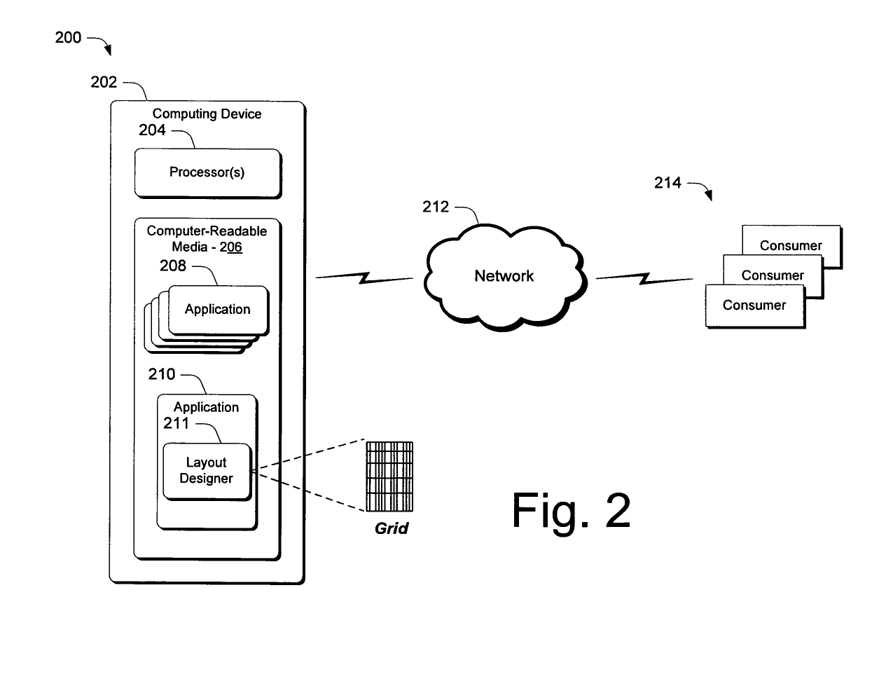

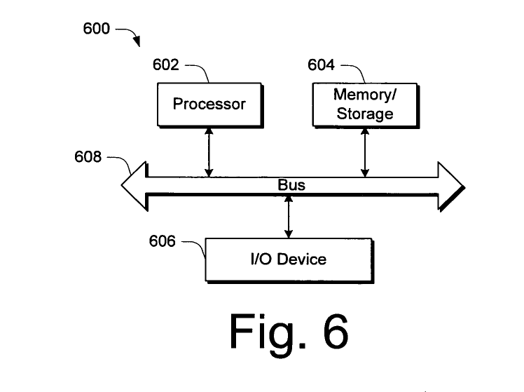

FIG. 2 illustrates an operating environment in accordance with one or more embodiments, generally at 200. Environment 200 includes a computing device 202 having one or more processors 204, one or more computer-readable media 206 and one or more applications 208 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

In addition, computing device 202 includes a software application 210 having a layout designer component 211 that can enable designers to layout and define content layout using the inventive grid position system described above and below. Any suitable application can be used.

In addition, environment 200 can include a network 212, such as the Internet, and one or more consumers 214 that can receive content that has been designed using the inventive principles described herein. Consumers 214 can take the form of any suitable computing device, examples of which are provided below.

Computing device 202, as well as consumers 214, can be embodied as any suitable computing device such as, by way of example and not limitation, a desktop computer, a portable computer, a handheld computer such as a personal digital assistant (PDA), cell phone, and the like.

Having discussed an example operating environment, consider now a discussion of an example grid unit, including grid declarations, and how the inventive grid unit can be used to enable grid positioning of content.

Example Grid Unit

One of the challenges with defining grid units is to have the grid be scalable to the overall size of an associated “container” or “content box” which defines an area in which content layout is to take place. The inventive grid unit or “gr” described just below is used to position content in relation to grid lines. In the illustrated and described embodiment, a grid unit is defined as the distance between two adjacent grid lines. For example, in an implicit grid produced by a multicolumn layout, each boundary between a column and a gap automatically produces a grid line. Therefore, to specify “two columns, including the gap between columns, but not including any gaps outside the columns” one can simply specify “3gr”. Actual values of each grid unit can vary depending on grid cells with which it is used. As an example, consider the following expression which is used to position an image:

div { columns: 4; }
div img { position:absolute; left:2gr; width:3gr; }

This expression positions the referenced image over the second and third columns (i.e., the left edge of second column is the second grid line from the left; and, two columns and a gap are defined by three grid lines).

In addition, fractions of grid units can be used as in the example expression just below:
div img {position:absolute; left:0.5gr; width:2gr;}

Here, the referenced image takes the width to stretch from the middle of the first column to the middle of second column. The “width:2gr” in the example does not start exactly from a grid line. Therefore, it is calculated as a sum of grid parts (2gr=0.5gr+1gr+0.5gr), which ends in the middle of the second column.

Note that a grid unit is positional. Accordingly, its value in absence of position is ambiguous. To resolve the ambiguity, when position is not set, one solution is that 1gr may be replaced with 100% and is then calculated according to the rules applied to percentages. Other solutions can, of course, be provided.

In the examples that follow, the inventive grid unit is used in different contexts depending on how a grid is declared.

In the illustrated and described embodiments, grids can be declared in different ways. For example, a grid can be explicitly declared using grid-columns, and grid-rows properties. These types of grid are referred to as explicit grids. Alternately or additionally, a grid can be impliedly defined by elements with a natural grid structure, such as multi-column elements and tables, or by default.

With respect to an explicitly-declared grid, consider the following. In explicitly-declared grids, outer edges of a content box define the grid lines. In a left-to-right layout, left and top edges define lines which are referred to as horizontal and vertical line zero. In a right-to-left layout, right and top edges define the horizontal and vertical line zero. The opposite edges also define grid lines. Additional grid lines can be added in the middle using ‘grid-columns’ and ‘grid-rows’ properties. As an example of grid-columns and grid-rows properties, consider the following property definitions.

grid-columns

| | |
|---|---|
| Value | [[<length>\|<percentage>\|<fraction>] \| |
| | ([<length>\|<percentage>\| |
| | <fraction> ]+)[‘[’<integer>‘]’]? ]+ \|none \| inherit |
| Initial | None |
| Applies To | All elements |
| Inherited | No |
| Percentages | Refer to width of containing block |
| Media | Visual, paged |
| Computedvalue | Specified value |

grid-rows

| | |
|---|---|
| Value | [[<length>\|<percentage>\|<fraction>] \| |
| | ([<length>\|<percentage>\| |
| | <fraction> ]+)[‘[’<integer>‘]’]? ]+ \|none \| inherit |
| Initial | None |
| Applies To | All elements |
| Inherited | No |
| Percentages | Refer to height of containing block |
| Media | Visual, paged |
| Computedvalue | Specified value |

Space for each column or row of the grid can be defined in terms of a length (grid units can be used to define a length), a percentage of a containing block (i.e. a content box) height and width, or a fraction. A fraction is a non-negative floating point number followed by “fr”. Each fraction values takes a portion of available space proportional to the number.

For example, the following rule or expression adds one grid line in the middle of a containing block, another grid line 4em from the right, and another grid line in the middle of remaining space:
div {grid-columns: 50% 1fr 1fr 4em}

In addition, grid lines can be defined in repeating groups using a repeating mechanism. A group is enclosed in parentheses and optionally specifies a maximum number of repetitions, an example of which appears below. As an example, consider the following rule or expression:
div {grid-rows: 4em repeat (0.25em 1em);}

This rule defines a header row of 4em and adds as many additional rows as necessary, alternating heights of 0.25em and 1em. Note that grid lines are added regardless of limitations on vertical space.

Alternately or additionally, the repeating mechanism can be used to define a fixed number of repetitions. For example, such can be done using the following rule or expression:
div {grid-rows: 4em repeat(10em, 5)

This rule defines a header row of 4em and adds five rows of 10em height.

With respect to an implied or implicit grid, consider the following. Elements with an implicit grid structure automatically define a grid that aligns with the structure. Such elements include multi-column elements and tables. In multi-column elements, left and right edges of each column form a grid line. There are twice as many grid lines as there are columns. In table elements, there is one grid line per row and per column. The grid line is at the row/column boundary. When there is no space between rows/columns, pairs of adjacent grid lines can be created. A possible alternative could merge adjacent pairs into single lines.

If explicit grid properties—grid-columns or grid-rows—are specified on an element with an implicit grid, the explicit properties have priority.

With respect to a default grid, an element that does not define an explicit grid and is not a member of any elements defining an implicit grid may be considered to have a single-cell grid, equivalent to having the explicit definition shown just below:
{grid-columns:1fr; grid-rows:1fr;}

Having now considered some examples of grid declarations, consider now some specific examples, a first of which illustrates an implied grid having an explicit grid declaration, the second of which illustrates an explicit grid.

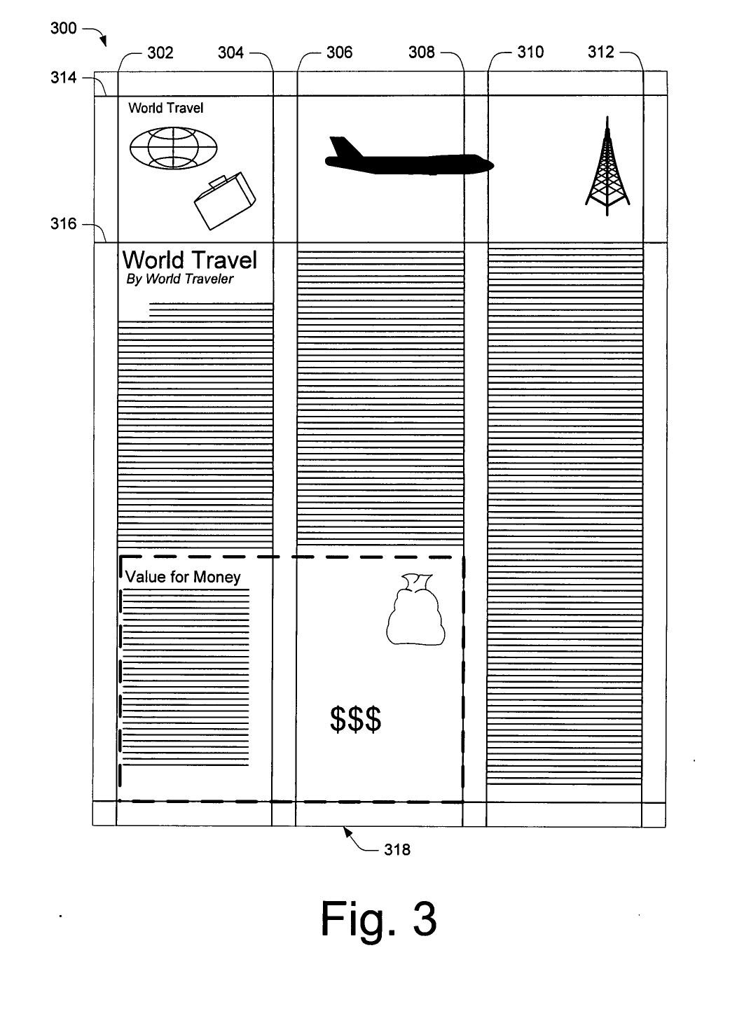

FIG. 3 illustrates a three-column layout in paged media generally at 300. Here, a grid can be seen to comprise six vertical lines 302, 304, 306, 308, 310, and 312, and two horizontal lines 314 and 316. The inventive grid unit can be used to position a floating image 318 (set off by the dashed rectangle) using the following expression:

body { columns:3; column-gap:2em; }
float1 { float:page bottom left; width:3gr; }

The statement “float:page bottom left” positions the image at the bottom left corner of the page.

The property “width:3gr” defines the image to be 3 grid units wide, where a “grid unit” is the distance between two adjacent grid lines. Each boundary between a column and a gap automatically produces a grid line, therefore to specify “two columns, including the gap between columns, but not including any gaps outside the columns”, one can specify “3gr”.

Additionally, in this example, the designer has added a horizontal line 316 with which to align illustrations. This can be done by explicitly defining grid lines as set forth in the following expression:

```
body { columns:3; column-gap:2em;
    grid-rows: 1.5in 1fr; }
div.illustrations
    { float:page top left; width:100%; height:1gr;}
float1 { float:page bottom left; width:3gr; }
```

Here, the expression above is used to position both images that appear in the Figure. Specifically, the “float:page top left; width:100%; height:1gr” positions the top most images (defined to be as wide as the page (100%) and as tall as the spacing of the first grid line (1gr), while the “float:page bottom left; width:3gr” positions the side story (i.e. “Value for Money and its related images) as described above. In this example, “grid-rows” divides vertical space with explicit grid lines. “1fr” is a flex unit (“fr” for “fraction”). If multiple flex units are used, they take space proportional to their values. If one wished to define vertical lines that would exactly match the 3-column layout with 2em gaps, the following expression could be used:
grid-columns: 1fr 2em 1fr 2em 1fr;

When only one value has a “fr” unit (as in “grid-rows: 1.5 in 1fr” above), it takes all of the remaining space regardless of the number.

Here, the expressions used above make use of an implied grid and combine with it an explicit grid definition.

The previous example addressed a situation in which grid lines are created automatically by a multi-column layout, also referred to as an implied or implicit grid. In more complex pages, the base grid of the page is designed in advance. Thus, it is not necessarily used to be filled with content directly. Rather, elements of the page are aligned to the grid. For this case, the grid can be specified explicitly and it is not required, although quite common, for the grid to have evenly spaced columns with gaps and between.

The additional grid lines, as in the example above where a horizontal line was added by the designer, enable elements to be positioned in ways that would not be possible otherwise. As another example, consider the following expression:

| body { grid-columns: 1fr 1fr repeat(0.5in 1fr 1fr, 2); | | |
|---|---|---|
| grid-rows: 20% 1fr; | | |
| columns:3; column-gap:0.5in; } | | |
| img | { | position:absolute; |
| | | left:4gr; |
| | | top:1gr; |
| | | width:3gr; |
| | } | |

In this example an explicit grid is specified aligned with the columns. The expression that appears in the “body” element defines the explicit grid. The expression that appears in the parentheses in the “body” element defines a repeating pattern. The integer at the end in the parentheses defines a number of repetitions. Further, the “fr” syntax represents a proportional length where each “fr” receives an equal space allocation. For example, using this syntax, one can specify 2fr, 3fr and the like. Further, the expression that appears in the “img” element defines the positioning of the image relative to the explicit grid.

In one or more embodiments, positioning methodologies can address situations in which a layout tries to address lines that lie outside of the defined grid, e.g. outside of a three-column layout or by using negative grid lines. In these situations there are a number of options that can be employed. For example, the whole grid or a portion thereof (e.g. the last row/column) could be repeated. Alternately or additionally, the grid can be mirrored into an overflow. For example, if a grid were to be specified to have three columns and an attempt was made to use a fourth column, the dimensions of the last column or an adjacent might be mirrored to add a fourth column. Alternately or additionally, an explicit grid definition can be provided in an overflow area. Alternately or additionally, undefined grid rows/columns can be set to zero. Alternately or additionally, undefined grid rows/columns can be set to a fixed size. Yet another alternative would be to have grid lines be adjusted by content (more or less as a table). For example, a grid might be specified that does not specify widths or heights. In this instance, the grid would grow as dictated by the content. For example, a grid might be specified for thumbnail images. In this case, grid columns would be dimensioned to be as wide as the widest thumbnail image. In this manner, grid lines would be defined based on the dimensions of the content.

Example Methods

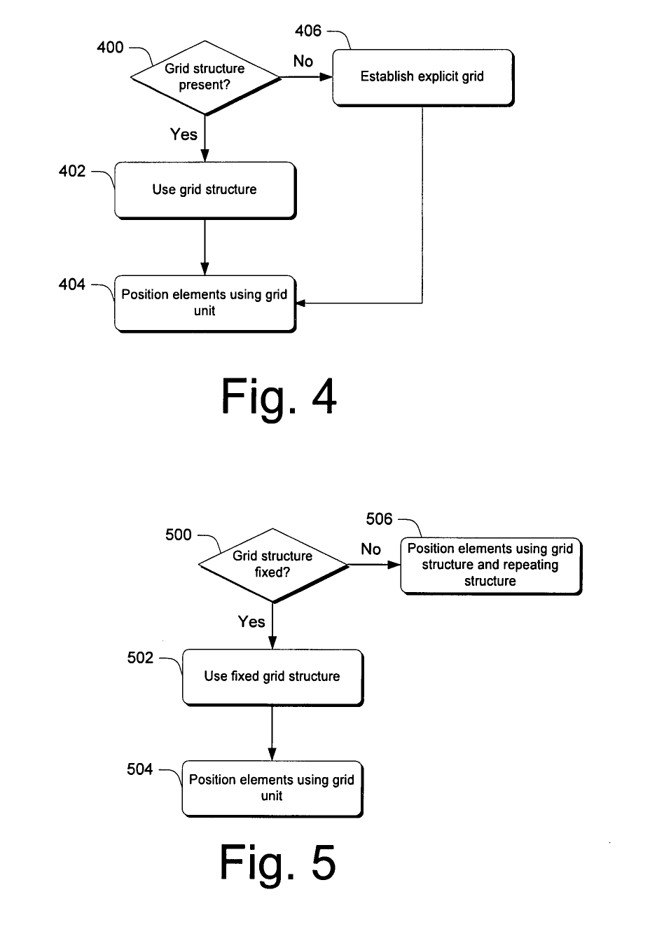

FIG. 4 is a flow diagram that describes steps of a design methodology in accordance with one or more embodiments. The method can be implemented in connection with any suitable hardware, software, firmware, or combination thereof. In one or more embodiments, the method can be implemented, at least in part, using a layout designer component such as the one described in FIG. 2.

Step 400 ascertains whether a grid structure is present with respect to a layout container in which content is to be laid out. If a grid structure is present, then step 402 uses the implicit grid structure and step 404 positions elements using a grid unit. An example of how this can be done is provided above with respect to FIG. 3. If, on the other hand, a grid structure is not present, then step 406 establishes an explicit grid and step 404 positions elements within the explicit grid using the grid unit. An example of how this can be done is provided above.

FIG. 5 is a flow diagram that describes steps a design methodology in accordance with one or more embodiments. The method can be implemented in connection with any suitable hardware, software, firmware, or combination thereof. In one or more embodiments, the method can be implemented, at least in part, using a layout designer component such as the one described in FIG. 2.

Step 500 ascertains whether a grid structure is fixed. A grid structure can be fixed by having a fixed number of columns. If the grid structure is fixed, step 502 uses the fixed grid structure and step 504 positions elements using a grid unit. If, on the other hand, the grid structure is not fixed, step 506 positions elements using the grid structure and a repeating structure. An example of how this can be done is provided above. Specifically, an example repeating structure is used in the form of the “fr” syntax in the above examples. The “fr” syntax represents a flexible unit that can be used to define how space is distributed.

Example System

FIG. 6 illustrates an example computing device 600 that can implement the various embodiments described above. Computing device 600 can be, for example, computing device 202 of FIG. 2 or any other suitable computing device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth. Using the computing device 600, a designer can utilize the principles described above to layout content.

Various techniques may be described herein in the general context of software or program modules or components. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a grid positioning system which allows grid lines to be established based upon either an implicit grid or an explicit grid. Further, at least some embodiments provide a grid positioning system which allows a repeating mechanism to be employed which is ideally suited to adapt to different screen or display resolutions. Further, various embodiments provide a language which defines a grid unit that can be utilized to allow positioning in relation to grid lines.

In at least some embodiments, the grid positioning system provides capabilities for sizing and positioning content in terms of a scalable grid. The grid can be specified directly by an author, or can be implied from existing two-dimensional structures such as tables or multi-column elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media having computer-readable instructions thereon which, when executed, provide a layout designer component configured to:
allow grid lines to be established on an implicit grid and an explicit grid; and
allow a grid unit to be used to position content in relation to the grid lines.

2. The one or more computer-readable media of claim 1, wherein the grid unit is defined as a distance between two adjacent grid lines.

3. The one or more computer-readable media of claim 1, wherein the layout designer component enables fractions of grid units to be used to position content.

4. The one or more computer-readable media of claim 1, wherein the layout designer component enables grid lines to be established using grid column properties and grid row properties.

5. The one or more computer-readable media of claim 4, wherein grid columns and grid rows can have associated space defined by one or more of length, percentage of a containing block height and width, or a fraction.

6. The one or more computer-readable media of claim 5, wherein individual fraction values take a portion of available space proportional to a specified number.

7. The one or more computer-readable media of claim 4, wherein the layout designer component gives priority to explicitly declared grid column properties and grid row properties when explicitly declared properties are used in connection with an implicit grid.

8. The one or more computer-readable media of claim 1, wherein the layout designer component further allows a repeating mechanism to be employed to repeat grid lines.

9. The one or more computer-readable media of claim 8, wherein the repeating mechanism allows one or more of:
grid lines to be repeated in groups of grid lines; or
a maximum number of repetitions to be specified.

10. A method implemented at least in part with a computer, the method comprising:
establishing a grid having grid lines, the grid lines being useable to position content in relation to the grid lines; and
using, during said establishing, a repeating mechanism to repeat one or more grid lines to establish the grid.

11. The method of claim 10, wherein said establishing is performed by establishing the grid lines relative to an implicit grid.

12. The method of claim 10, wherein said establishing is performed by establishing an explicit grid.

13. The method of claim 10, wherein said establishing comprises using one or more of grid column properties or grid row properties to establish said grid.

14. The method of claim 13, wherein grid columns and grid rows can have associated space defined by one or more of length, percentage of a containing block height and width, or a fraction.

15. The method of claim 14, wherein said length can be defined in terms of grid units, a grid unit being defined as a distance between two adjacent grid lines.

16. A method implemented at least in part with a computer, the method comprising:
establishing a grid having grid lines, the grid lines being useable to position content in relation to the grid lines; and
positioning content relative to the grid, said positioning using a grid unit to position said content, said grid unit being defined as a distance between two adjacent grid lines.

17. The method of claim 16, wherein said establishing is performed by establishing the grid lines relative to an implicit grid.

18. The method of claim 16, wherein said establishing is performed by establishing an explicit grid.

19. The method of claim 16, wherein said establishing comprises using a repeating mechanism to repeat one or more grid lines.

20. The method of claim 16, wherein said positioning comprising using a grid unit fraction to position said content.
